(19) United States
(12) Patent Application Publication
(10) Pub. No.: US 2020/0005599 A1
(43) Pub. Date: Jan. 2, 2020

(54) DRAW GAME TICKETS WITH EXTRA INSTANT GAME OPTION HAVING WIN STATUS DEPENDENT UPON PREVIOUS DRAW GAMES, AND INSTANT GAME TICKETS HAVING WIN STATUS DEPENDENT UPON PREVIOUS DRAW GAMES

(71) Applicant: Diamond Game Enterprises, Chatsworth, CA (US)

(72) Inventor: William F. BRESLO, Topanga, CA (US)

(21) Appl. No.: 16/020,182

(22) Filed: Jun. 27, 2018

(51) Int. Cl. G07F 17/32; G07F 17/42

(52) U.S. Cl. CPC G07F 17/3267; G07F 17/42; G07F 17/329; G07F 17/3223

(57) ABSTRACT

A gaming system is provided wherein draw game tickets have an extra instant game option wherein the win status of the extra instant game is dependent upon previous draw games. The gaming system also provides for instant game tickets having a win status dependent upon previous draw games.

### BACKGROUND OF THE INVENTION

Draw games and instant games are two types of well-known games. In a draw game, the player must wait until a window of time closes, and then a drawing is held to select the winning ticket numbers. The players then compare the numbers on their ticket receipts to the winning numbers. In an instant game, the outcome of the game play (win or lose) is immediately available to the player.

Both types of games typically provide a player with a paper receipt which includes at least the set of numbers (or symbols that represent numbers) associated with game play. FIG. 1A shows a paper receipt that is provided when playing an instant game described in U.S. Pat. No. 7,695,360 (Breslo). FIG. 1B shows a player's paper receipt provided for an instant game known as EuroMillions®, which is a transnational European lottery requiring seven correct numbers to win the jackpot. FIG. 1C shows a paper receipt provided to the player in the multistate draw game known as Powerball®. FIG. 1D shows a paper receipt provided to the player in the draw game Keno 4 Spot held by the Pennsylvania lottery. The draw game receipts typically show the date of the draw, the set of numbers, and whether the numbers were selected as a “quick pick” (designated by the initials “QP” printed on the ticket), which is discussed below in more detail.

Draw games and instant games are typically provided on completely different gaming platforms and typically use different ticket formats. Thus, there is generally no mixing and matching of instant game features in draw games, and vice-versa.

U.S. Pat. No. 8,651,935 (Caro et al.) discloses a combined future lottery (draw game) and optional instant game. However, the two types of games do not interact in the manner of the present invention, as discussed in further detail below.

Players today want instant gratification which is not afforded by draw games which have set draw times. Furthermore, revenue generation in draw games is limited to the number/frequency of draws. Instant games do not suffer from such limitations, but significant infrastructure already exists for draw games that lottery systems do not wish to abandon draw games and solely offer instant games. Furthermore, many draw games, such as Powerball, have significant game recognition/popularity and provide significant revenue to the participating states. It would be ideal if draw games could be leveraged for increased game play opportunities by allowing for some form of instant game to be associated with the draw games.

The present invention fulfills such needs by allowing players to participate in instant games between draw games, and to do so without the deficiencies and limitations inherent in Caro et al. This allows existing instant game platforms to be leveraged for additional revenue opportunities.

While this invention achieves a significant business goal, it does so via an inventive technical solution that requires the use of a technological component, namely, a random number generator, and an inventive process that compares the result of the random number generator to values that, heretofore, were not used in any such manner.

### SUMMARY OF THE PRESENT INVENTION

A gaming system is provided wherein draw game tickets have an extra instant game option wherein the win status of the extra instant game is dependent upon previous draw games. The gaming system also provides for instant game tickets having a win status dependent upon previous draw games.

### BRIEF DESCRIPTION OF THE DRAWINGS

Preferred embodiments of the present invention will now be described by way of example with reference to the accompanying drawings:

FIGS. 1A-1D show prior art ticket receipts for prior art instant games and draw games.

FIG. 2 is a schematic diagram of a system for implementing preferred embodiments of the present invention.

FIGS. 3A and 3B show sample tickets produced using one preferred embodiment of the system of FIG. 1.

FIG. 4 shows data tables for use in preferred embodiments of the present invention.

FIGS. 5A and 5B show another sample ticket produced using another preferred embodiment of the system of FIG. 1.

FIG. 6 shows another data table for use in another preferred embodiment of the present invention.

### DETAILED DESCRIPTION OF THE INVENTION

Certain terminology is used herein for convenience only and is not to be taken as a limitation on the present invention.

The words “a” and “an”, as used in the claims and in the corresponding portions of the specification, mean “at least one.”

### I. DETAILED DESCRIPTION

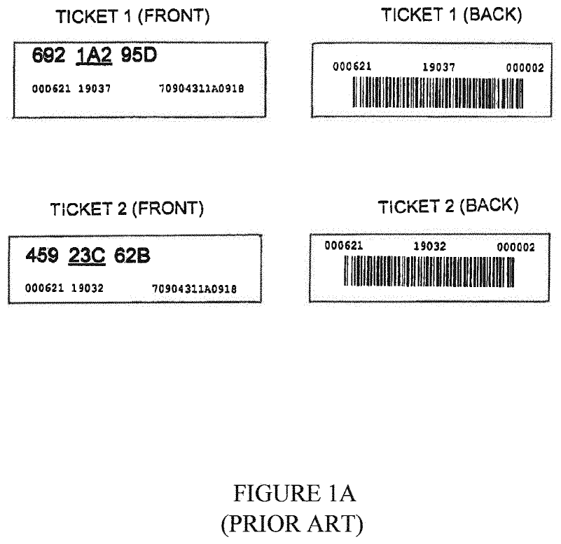

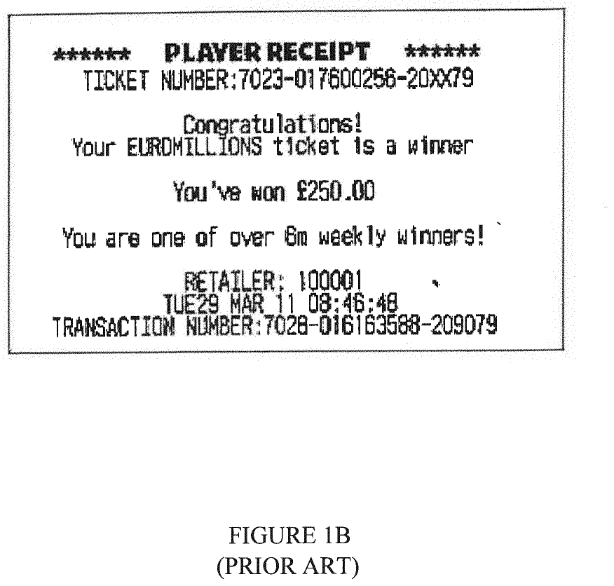

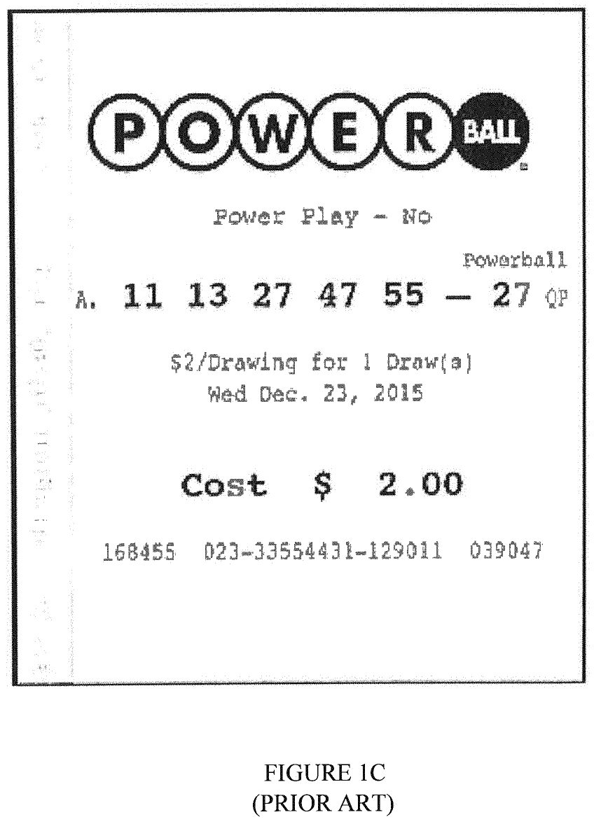

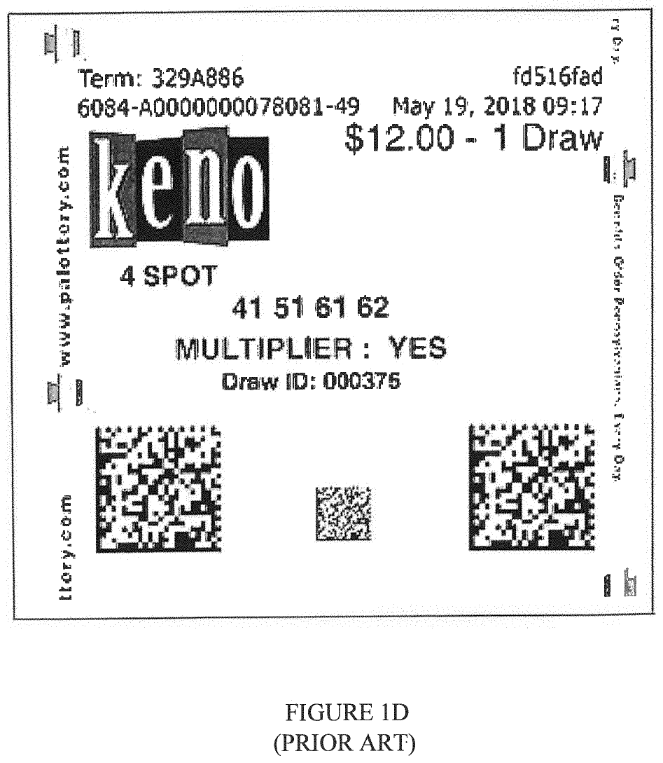

FIG. 1 shows a gaming system 100 for implementing one preferred embodiment of the present invention. The gaming system 100 includes gaming server 102, a plurality of remotely located gaming terminals 104₁ to 104ₙ, hereafter individually referred to as “gaming terminal 104,” and an electronic network 106 (e.g., Internet, LAN) for connecting gaming terminal 104 with the gaming server 102.

The gaming server 102 is configured to administer a plurality of successively occurring draw games and a plurality of instant games. The draw game may be any conventional type of draw game, such as a lottery-type game, keno, or bingo (not “instant bingo”).

To facilitate these games, the gaming server 102 includes a random number generator (RNG) 108. The RNG 108 performs two distinct functions. First, the RNG 108 generates results for the draw games, wherein each draw game has its own results. Second, the RNG 108 selects a player's draw game entry numbers upon request by the player to have the gaming server 102 select the numbers. This feature is known in the art as a “quick pick” option. Most lotteries provide this option to the player as an alternative to allowing the player to pick their game entry numbers. If a particular gaming system 100 does not allow for a “quick pick” option, then the RNG 108 only needs to provide the first function.

Each gaming terminal 104 includes an input device 110 configured to receive from the player at least the following information when the player wishes to add one or more instant games to the draw game ticket:

i. player-selected draw game entry numbers for a future one of the draw games, or a request for the gaming server 102 to randomly select the player's draw game entry numbers via a “quick pick” option, if the gaming system 100 provides for such an option, and

ii. a request to purchase one or more instant games, if desired by the player.

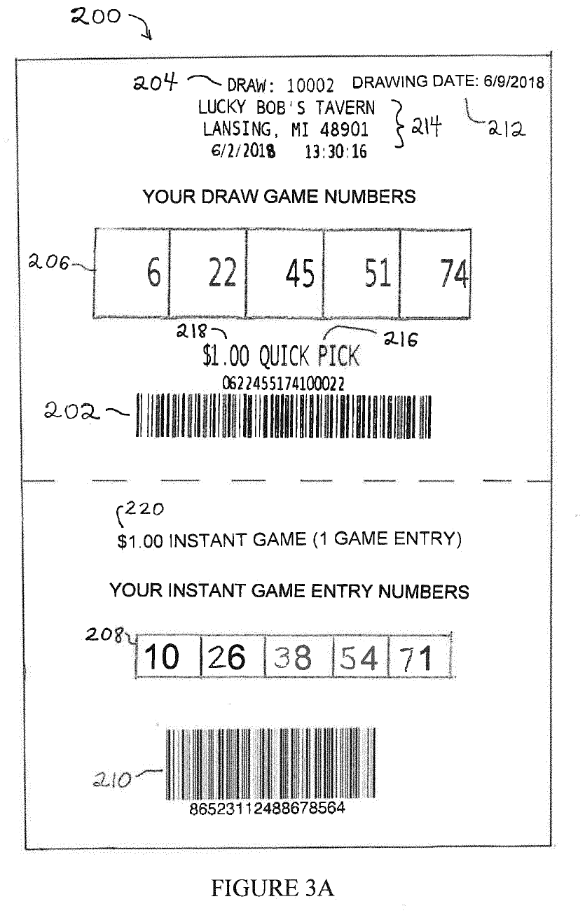

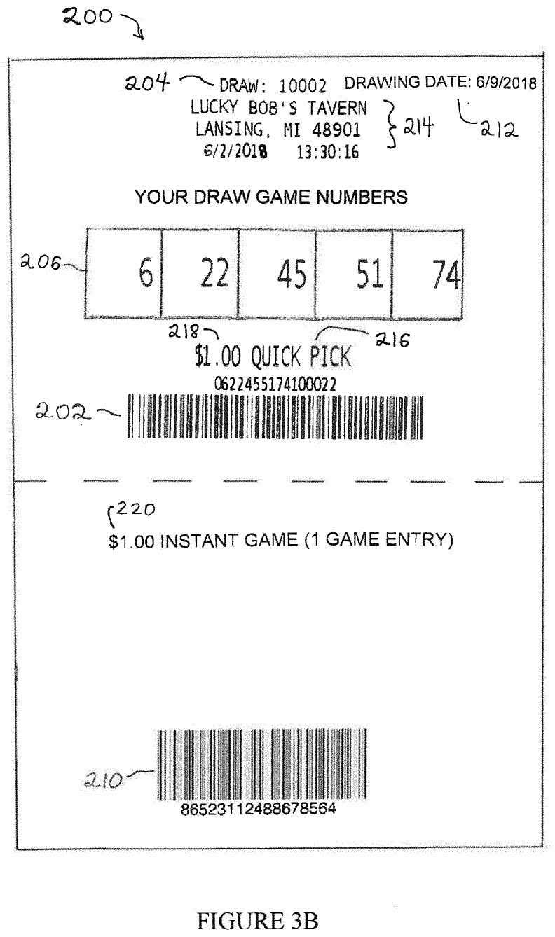

Each gaming terminal 104 also includes a ticket printer 112 configured to print out a ticket for the player. FIG. 3A shows a sample ticket 200. The ticket 200 includes at least the following items that are printed on the ticket 200:

i. a draw game ticket identifier 202,

ii. a future draw game identifier 204 that identifies a future draw game that the ticket is purchased, and the draw game entry numbers 206 for the future draw game, and

iii. the one or more instant game entry numbers 208, and an instant game identifier 210 that may be used to initiate a display of game results for the instant game. These items are printed only if the player requested to purchase one or more instant games.

For simplicity, FIG. 3A shows only one set of draw game entry numbers 206 and one set of instant game entry numbers 208. However, as discussed below, the gaming system 200 may allow for the player to select a plurality of sets of draw game entry numbers 206 and/or a plurality of sets of instant game entry numbers 208. Also, in the example of FIG. 3A, the draw game entry numbers 206 were selected via a “quick pick” option.

The one or more instant game entry numbers 208 are selected by the RNG 108 in a manner similar to the conventional “quick pick” for a draw game. There is no option for the player to select the instant game entry numbers 208 for the reasons discussed below.

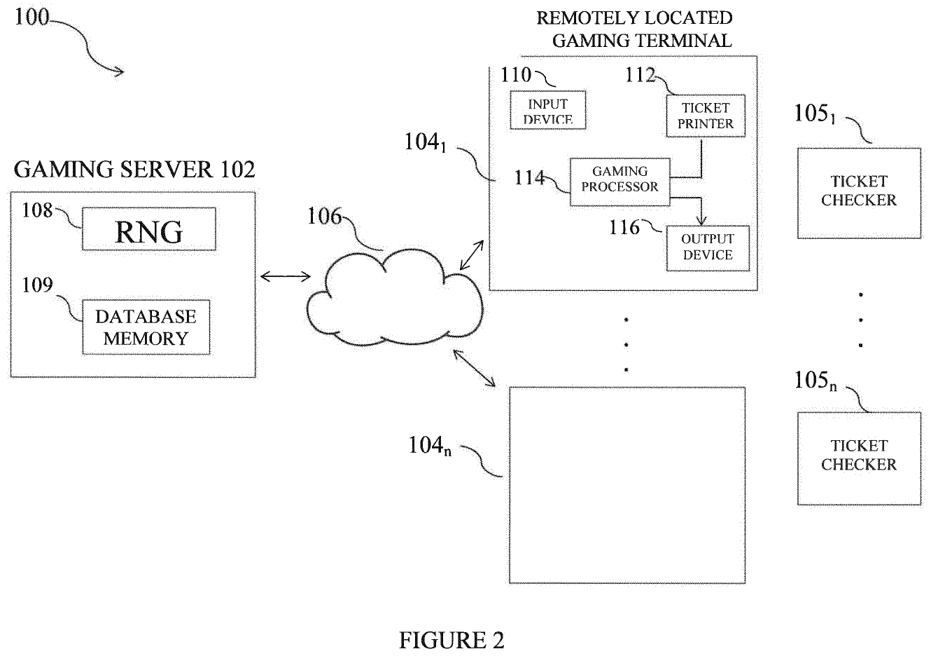

In the embodiment shown in FIG. 2, the draw game ticket identifier 202 is distinct from the instant game identifier 210. However, in an alternative embodiment wherein the ticket identifiers are merely pointers to table locations that contain the ticket game numbers, the ticket identifier 202 may be used as the instant game identifier 210. Database memory 109 in the gaming server 102 is configured differently, depending upon which embodiment is used. In one embodiment, the database memory 109 in the gaming server 102 maintains two separate tables of ticket identifiers, one for the draw game ticket identifiers 202 and their respective draw game entry numbers 206, and one for the instant game identifiers 210 and their respective instant game entry numbers 208. In the alternative embodiment, each ticket has only a single ticket identifier, and the database memory 109 in the gaming server 102 maintains only one table of ticket identifiers, with each ticket identifier including the respective draw game entry numbers 206 and the instant game entry numbers 208.

If the ticket identifiers 202 and 210 are encoded with the actual ticket game numbers, and are not merely pointers to database records, then two separate ticket identifiers are preferably used so as to simplify the encoding, decoding and complexity of the respective ticket identifiers. In the example shown in FIG. 3A, the draw game identifier 202 is encoded with the actual draw game entry numbers 206, the future draw game identifier 204, and a checksum. The instant game identifier 210 is encoded with a pointer to the actual instant game entry numbers 208.

In the example shown in FIG. 3A, the draw game is a bingo draw game so each of the five number must be selected from a range of numbers, either by the player of via a computer-selected “quick draw” option. The range of numbers increase from the first number to the fifth number. In other types of draw games, any number within a range (e.g., 1-99) may be selected for each of the numbers.

Other indicia may be shown on the ticket 200, such as the drawing date of the draw game 212, the ticket purchase location and date/time of purchase 214, indicator of whether the draw game entry numbers were player-selected or computer-selected via a “quick draw” option 216, draw game ticket amount 218, instant game ticket amount 220, verification/tracking numbers (not shown), and the like.

Each gaming terminal 104 also includes a local gaming processor 114 configured to receive data from the input device 110, perform any necessary communications with the gaming server 102, and control the ticket printer 112.

An important feature of the present invention is that the results of previous draw games are used to determine winners of subsequently purchased instant games. Since the results of previous draw games are publicly known, the one or more instant game entry numbers 208 must be selected by the RNG 108, not by the player. Otherwise, the player would simply select known, winning numbers.

The gaming server 102 is configured to perform at least the following functions for each ticket 200:

i. Identify whether the ticket 200 is a winning ticket with respect to the future draw game by comparing the results for each draw game with the draw game identifier 204 and draw game entry numbers 206 on the tickets, and

ii. Identify whether the ticket 200 is a winning ticket with respect to the one or more instant games by comparing the results of one or more previous draw games with the one or more instant game entry numbers 208.

The instant ticket game results are available immediately after the ticket 200 is printed, whereas the future draw game results become available only when the future draw game results are generated. The gaming terminal 104 may include an output device 116 configured to display game results to the player regarding the one or more instant games on the ticket 200. In one embodiment, the instant game identifier 210 may be a bar code or the like that passes by a scanner (not shown) internal to the gaming terminal 104. The gaming terminal 104 communicates the instant game identifier 210 to the gaming server 102 and receives back information that is used to generate the display on the output device 116 indicating whether the ticket 200 includes any winning or losing instant games. In an alternative embodiment, the player may bring the ticket 200 to a nearby ticket checker 105 that provides the same functionality as the internal scanner and display of the output device 116. One example of such a ticket checker 105 is disclosed in U.S. Patent Application Publication No. 2017/0053495 (Breslo et al.), which is incorporated by reference herein. The game results would be displayed upon scanning of the instant game identifier 210 by a player-accessible scanner of the ticket checker 105. If the player accidentally scans the draw game identifier 202, the ticket checker 105 may either ignore the ticket and not respond with any message, or the ticket checker 105 may be programmed to read the draw game identifier 202 and respond with a message, such as “THIS BAR CODE IS FOR YOUR DRAW GAME WHICH WILL OCCUR ON DATE X. IF THERE IS ANOTHER BAR CODE ON YOUR TICKET ASSOCIATED WITH AN INSTANT GAME, SCAN THAT BAR CODE NOW TO FIND OUT IF YOUR TICKET IS A WINNER.”

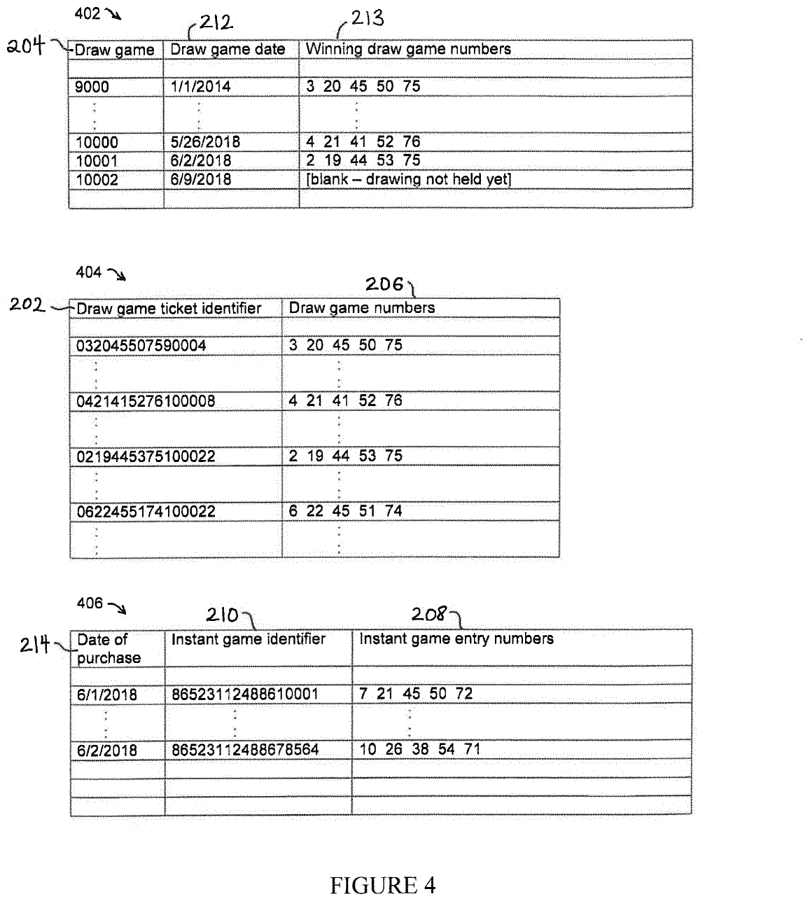

FIG. 4 shows sample data tables for implementing the above-described embodiments of the present invention. For illustration purposes, the ticket data of the ticket shown in FIG. 2 is used in the data tables.

A first data table 402 maintains winning draw game numbers 213 for respective draw games. In this example, there is only one winning draw game number per draw game. However, in other embodiments, there may be multiple winning draw game numbers 213 per draw game.

A second data table 404 maintains the draw game ticket identifiers 202 and their respective draw game numbers 206. In this example, there is only one set of draw game numbers 206 associated with a draw game ticket identifier 202. However, if the option to purchase multiple sets of draw game numbers 206 is available when purchasing a ticket 200 (for an additional multiple of the ticket base amount), there may be multiple sets of draw game numbers 206 associated with a single draw game ticket identifier 202.

A third data table 406 maintains a date of purchase of the ticket 200, instant game identifiers 210 and their respective instant game entry numbers 208. In this example, there is only one set of instant game entry numbers 208 associated with an instant game identifier 210. However, if the option to purchase multiple sets of instant game entry numbers 208 is available when purchasing a ticket 200 (for an additional multiple of the instant game base amount), there may be multiple sets of instant game entry numbers 208 associated with a single instant game identifier 210.

These data tables may contain many additional fields. The fields that are illustrated are the ones that are most relevant to an understanding of the present invention.

In one preferred embodiment, the gaming server 102 is configured to identify whether the ticket 200 is a winning ticket with respect to one or more instant games by comparing the results of only the immediately preceding draw game with the one or more instant game entry numbers 208. In the example of FIG. 4, the set of instant game entry numbers 208 associated with the ticket 200 shown in FIG. 3A, which was purchased on 6/2/2018 and has instant ticket game identifier “86523112488678564” (shown in the third data table 406), is compared only to the set of winning draw game numbers 213 of the draw game held on 5/26/2018 (shown in the first data table 402). Stated another way, the winning draw game numbers 213 of the draw game held on 5/26/2018 becomes the “control number” that the set of instant game entry numbers 208 must be matched to. Here, there is no match since “10 26 38 54 71” does not match any of the numbers “4 21 41 52 76.” Thus, the instant game played on the ticket 200 is not a winner. This result would be indicated either during dispensing of the ticket 200 from the output device 116 of the gaming terminal 104, or at a ticket checker 105 by scanning the instant game identifier 210.

As discussed above, U.S. Pat. No. 8,651,935 (Caro et al.) discloses a combined future lottery (draw game) and optional instant game. Caro et al. operates as follows:

1. A player makes a request at a terminal to enter a future draw game.

2. The player chooses and enters a set of numbers for the future draw game.

3. The player is offered an opportunity to enter an optional instant game as a supplement to the entry in the future draw game.

4. If the player wishes to enter the optional instant game, a set of instant game entry numbers are randomly generated.

5. The randomly generated set of instant game entry numbers are then compared to the player's chosen set of numbers for the future draw game.

6. If there is a match, the player wins a prize for the instant game. If there is no match, the player does not win a prize for the instant game.

Caro et al. does not compare the randomly generated set of instant game entry numbers to previous winning draw game numbers. Instead, Caro et al. only compares the randomly generated set of instant game entry numbers to the player's own entered set of numbers for the future draw game.

The process of the present invention has numerous advantages over Caro et al.

One advantage of the present invention over Caro et al. is that the player is not limited to using their future draw game numbers for playing the instant game, since the RNG 108 will pick a different set of numbers for the instant game. In Caro et al., the instant game automatically uses the future draw game numbers as the player's instant game numbers.

Another advantage of the present invention over Caro et al. is that the instant game(s) do not need to be played immediately upon ticket purchase, as discussed in more detail below. In one preferred embodiment, the quick pick numbers of the instant play are hidden (i.e., not shown on the ticket) and also not yet selected, thereby allowing the player to play the instant play game at any time subsequent to ticket purchase. Whenever the instant play game is played, the quick pick numbers of the instant play will be compared against the most recent draw game numbers. In another embodiment, the instant play game outcome is immediately determined by comparing the quick pick numbers against the most recent draw game numbers, but the game results are not revealed to the player, again allowing the player to play or reveal the outcomes at a future time. In Caro et al., the instant game is always played and revealed at the time of purchase, i.e. immediately.

Yet another advantage of the present invention over Caro et al. is that in one preferred embodiment, no draw game ticket needs to be purchased to play the instant game. In Caro et al., the player must play the future draw game. Otherwise, there is no set of numbers available to compare the instant game numbers to.

### II. ADDITIONAL CONSIDERATIONS

A. Draw Games Used for Determination of a Winning Ticket from the Instant Game Option

In one preferred embodiment discussed above, the gaming server 102 is configured to identify whether the ticket 200 is a winning ticket with respect to one or more instant games by comparing the results of only the immediately preceding draw game with the one or more instant game entry numbers 208. In an alternative embodiment, the gaming server 102 is configured to identify whether the ticket 200 is a winning ticket with respect to one or more instant games by comparing the results of a plurality of preceding draw games with the one or more instant game entry numbers 208. The rules of game, typically published by the gaming entity, will identify the exact manner of game play, including exactly which preceding draw game(s) are used for the comparison.

B. Number of Games on a Ticket

In one preferred embodiment, each game play is associated with a single ticket 200, and the single ticket 200 includes a single future draw game for the immediately upcoming draw game, and one or more instant games. However, the scope of the invention includes embodiments wherein the ticket 200 may include multiple future draw games. If the option for multiple future draw games is provided by the gaming system 200, the gaming terminal 104 preferably allows the player to indicate which future draw game(s) from a predefined list of future draw games (typically designated by a type of game and a draw date) the player wishes to purchase tickets for.

C. Funds Allocation

In one preferred embodiment, a base amount of funds is equal to the cost of the single future draw game, and additional multiples of the base amount of funds is equal to the cost of a corresponding multiple of instant games. In such an embodiment, each gaming terminal 104 is further configured to allocate funds received by the player first to the single future draw game, and then to the instant games.

For example, if the base amount is $1.00, funds are allocated as follows:

i. Player inputs $1.00. Printed ticket shows indicia for one draw game.

ii. Player inputs $2.00. Printed ticket shows indicia for one draw game and one instant game (winning status is based on immediately preceding draw game).

iii. Player inputs $5.00. Printed ticket shows indicia for one draw game and four instant games (winning status is based on previous four draw games).

Other combinations of funds allocations are within the scope of the invention. For example, the cost for one draw game may be a fraction of the base amount of funds for a single future draw game (e.g., $1.00 for draw game, $0.50 for instant game).

In one embodiment, the funds allocations are set by the game operator. However, in another embodiment, the player may select the funds allocation by indicating how much of the funds should be used for draw game selections and instant game selections, respectively.

D. Paytables

The gaming server 102 preferably uses paytables to determine the percentage of winning game results and the value of each winning game result. In one preferred embodiment, the same paytable is used for the draw games and the instant games. However, the scope of the invention includes embodiments where different paytables are used for the draw games and the instant games.

In the embodiment of shown in the figures, when using a conventional paytable structure, a match of all five instant game entry numbers 208 to the previously drawn winning draw game numbers 213 would have the highest value prize amount and the lowest probability of winning, whereas a match of two instant game entry numbers 208 to two of the previously drawn winning draw game numbers 213 would have the lowest value prize amount and the highest probability of winning (assuming that two matches is the lowest available win scenario).

E. No Draw Game Purchase Required

In an alternative embodiment, the player does not need to enter a draw game to purchase an instant game. However, the results of previous draw games are still used to determine winners of subsequently purchased instant games in the same manner as the embodiment disclosed above. This alternative embodiment expands the potential player market for participation in the gaming system 100 because some players may not wish to wait for a draw to occur to find out if a ticket in a winner, but may still wish to purchase instant tickets from the gaming system.

In this embodiment, the input device 110 does not receive player-selected draw game entry numbers or a request for the gaming server 102 to select such numbers via a quick pick option. Likewise, the ticket 200 does not include any identifiers associated with a future draw game, or any draw game entry numbers for a future draw game.

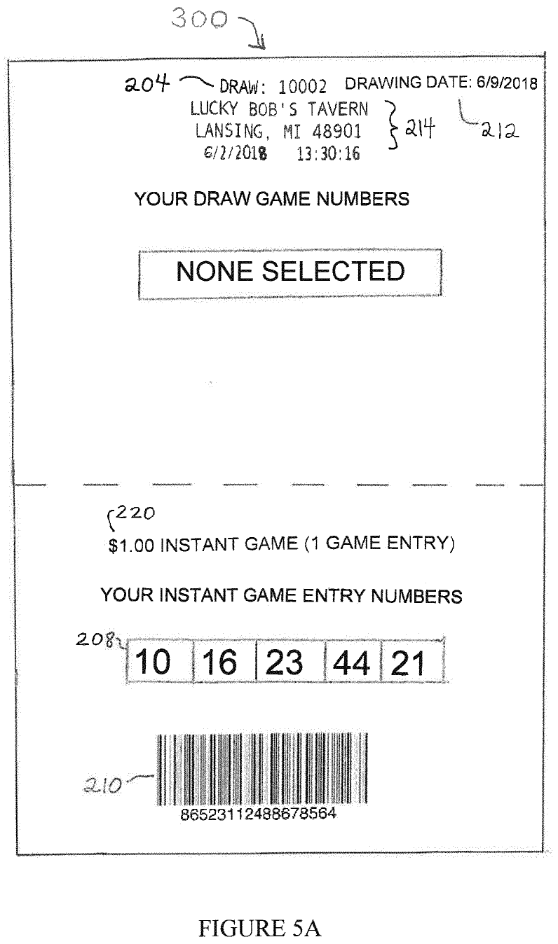

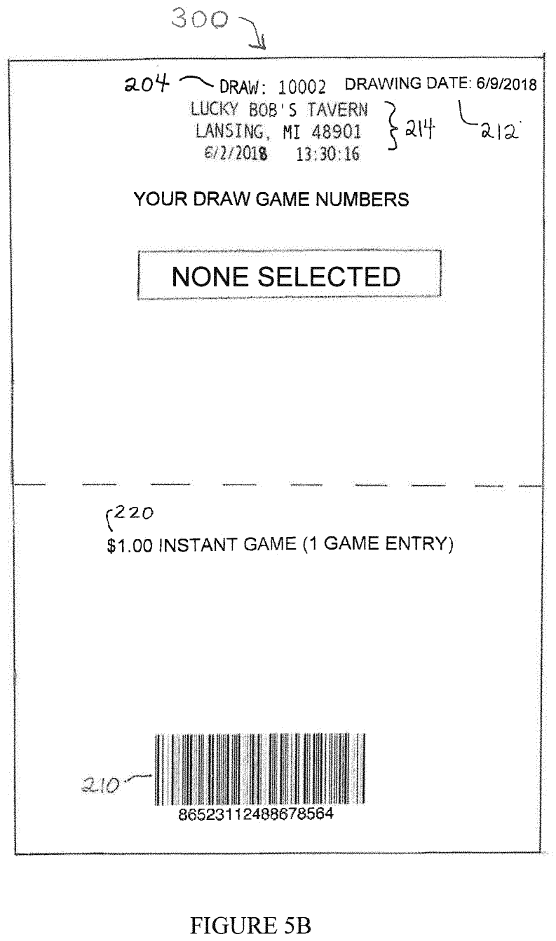

FIG. 5A shows an example of such a “draw game” only ticket 300. Instead of showing draw game numbers, the ticket 300 may show a message “NONE SELECTED.” Fields such as the draw number and draw date would be optional, since the player does not need to be reminded of this information.

In one version of this alternative embodiment, the input device 110 includes an initial prompt asking whether the player wishes to purchase a draw game ticket. If the player declines, the player is then prompted to purchase the instant ticket. Alternatively, these prompts may occur in reverse order. The ticket 300 shown in FIG. 5A relates to this version.

In another version of this alternative embodiment, the gaming terminal 104 is only configured to dispense instant tickets, and thus no prompts are given to the player regarding whether the player wishes to purchase a draw game ticket. In this version, the ticket 300 shown in FIG. 5A would be identical, except that it would not include the message portion that reads: “YOUR DRAW GAME NUMBERS: NONE SELECTED.” Also, fields such as the draw number and draw date would not be included since this information has no relevance to the player. In this version, other gaming terminals 104 and/or purchasing avenues would be provided for purchasing the draw game tickets. Also, some of those other terminals 104 may allow for combined draw game/instant game tickets.

F. Draw Game Ticket with Automatically Included Instant Game

In the draw game ticket embodiments described above, the instant game is an option that the player can add to the draw game ticket purchasing process, if desired. In an alternative embodiment, the gaming system 100 is configured to automatically include the instant game as part of the ticket purchasing process. Similarly, the tickets are advertised to the public as always including an instant game, potentially adding further consumer appeal to the tickets. In this embodiment, the ticket price and pay tables must be adjusted to account for the instant game winners. The results of previous draw games are still used to determine winners of subsequently purchased instant games in the same manner as the embodiment disclosed above.

G. Video Elements for Enhanced Game Play Experience

There has also been a significant migration to video in many forms of entertainment, which is not afforded by traditional instant games that are played primarily on paper “scratch-off” tickets. In preferred embodiments, the instant game results are experienced using video elements, thereby meeting the ever-increasing expectation by patrons that video play a role in their entertainment. As discussed above, the display on the output device 116, which is preferably a video display, indicates whether the ticket 200 includes any winning or losing instant games. In an alternative embodiment, the game results are displayed on a display of the ticket checker 105, which is also preferably a video display.

H. Ticket Displays Only an Instant Game Identifier, not the Set of Instant Game Numbers

In the embodiments shown in FIGS. 3A and 5A, the one or more instant game entry numbers 208 are printed on the tickets 200 and 300. Since these numbers are being compared to publicly available results of a previous draw game, the player can manually make the comparison to learn whether the instant game is a winner if the player wishes to do so. However, in one preferred embodiment, the ticket 200 or 300 does not show the one or more instant game entry numbers 208, but instead only shows the instant game identifier 210. FIGS. 3B and 5B show examples of such tickets 200 and 300, respectively. In this manner, the player is required to use a display to obtain the game results, thereby enhancing the play experience, although in a forced manner. The display may be either the ticket checker 105 described above, or the output device 116 of the gaming terminal 104 which reads the instant game identifier 210 via the internal scanner of the gaming terminal 104 and displays the game results. In the alternative embodiment described above wherein there is only one ticket identifier (e.g., the ticket identifier 202 is used as the instant game identifier 210), the ticket identifier 202 is used by the internal scanner of the output device 116 or the scanner of the ticket checker 105 to identify the set of instant game numbers maintained at the gaming server 102 for the determination and ultimate display of the instant game results.

In the embodiment wherein the ticket 200 or 300 displays only an instant game identifier and a ticket checker 105 is used to display the game results, the output device 116 preferably displays the instant game entry numbers 208 so that the player has confidence that the numbers were actually selected and associated with the instant game identifier 210. If desired, the player may manually write down the numbers or take a picture of the numbers with a mobile device. Furthermore, the player will be instructed to bring the ticket 200 or 300 to the ticket checker 105 to see the game results.

In the embodiment wherein the ticket 200 or 300 displays only an instant game identifier and the output device 116 of the gaming terminal 104 reads the instant game identifier 210 via the internal scanner of the gaming terminal 104 and displays the game results as the ticket 200 or 300 is being dispensed, the instant game entry numbers 208 are also preferably displayed so that the player has confidence that the numbers were actually selected and associated with the instant game identifier 210.

I. Quick Pick is Only Option for Draw Game Entry Numbers

In one alternative embodiment, the player does not have the option to select the draw game entry numbers 206 and must use the quick pick option. Thus, RNG 108 always selects not only the instant game entry numbers 208, but also the draw game entry numbers 206 for each ticket 200.

J. Set of Instant Game Entry Numbers May be Smaller or Larger than the Set of Draw Game Entry Numbers

In the example of FIGS. 3 and 4, the instant game entry numbers 208 are identical in length and format as the draw game entry numbers 206. However, the instant game entry numbers 208 may be shorter in length than the draw game entry numbers 206 and the game rules may simply dictate that a match of the instant game entry numbers 208 to a subset of the draw game entry numbers 206 indicates a winning result (i.e., a comparison that identifies a win).

Likewise, the instant game entry numbers 208 may be longer in length than the draw game entry numbers 206 and the game rules may simply dictate that a match of the instant game entry numbers 208 to the draw game entry numbers 206 indicates a winning result (i.e., a comparison that identifies a win).

K. Deferred “Playing” of Instant Game and Deferred Playing and Selection of Instant Game Entry Numbers

Referring again to FIGS. 3B and 5B wherein the instant game entry numbers 208 are not printed on the tickets 200 or 300, there are two different embodiments for selection of the instant game entry numbers 208. In one embodiment, the instant game entry numbers 208 are selected by the RNG 108 of the gaming server 102 immediately upon game ticket purchase and immediately recorded in the database table 406 of FIG. 4. In this embodiment, the game outcome is also determined at the time of ticket purchase by comparing the instant game entry numbers 208 to the previous draw game results. However, even though the game outcome has been determined, the player may wish to reveal the results (i.e., “play the instant game”) at a later point in time by using one of the ticket checkers 105 at a later point in time.

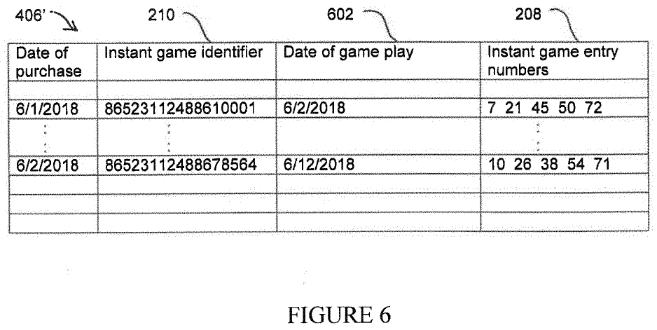

In an alternative embodiment, the gaming system 100 may be configured so that in the embodiments of FIGS. 3B and 5B, the instant game entry numbers 208 are not selected at the time of game purchase, but are selected only when the player scans the instant game identifier 210 at a ticket checker 105, thereby revealing the results (i.e., “playing the instant game”). In this embodiment, the instant game entry numbers 208 are likewise compared to the previous draw game results, but since time has passed, the previous draw game may be a later draw game than when the ticket 200 or 300 was initially purchased. Accordingly, the database table 406 includes an additional “date of game play” field, as shown in database table 406′ of FIG. 6. That is, in addition to the date of purchase, there is a date of game play 602. The date of game play, not the date of purchase, determines which draw game the instant game entry numbers 206 are compared to. In this example, a ticket 200 or 300 was purchased on 6/1/2018, but not “played” until 6/2/2018. Another ticket 200 or 300 was purchased on 6/2/2018, but not “played” until 6/12/2018.

The “deferred playing and selection” allows the player to decide when to experience the instant game. Furthermore, it allows tickets to be given to others after purchase, wherein the ticket recipient can likewise decide when to experience the instant game, without the ticket purchaser having any way of knowing if the ticket is a winner or not.

L. Ticket Checkers are Integrated into the Gaming Terminals

In one embodiment of the present invention, the ticket checkers 105 are physically separate devices from the gaming terminals 104. In another embodiment, the ticket checkers 105 are integrated into the gaming terminals 104, such that all of the functionality of the ticket checkers 105 are available at the gaming terminals 104. In this manner, a player may immediately scan a dispensed ticket 200 or 300 to obtain the game results of the purchased instant games using an external (player-accessible) scanner of the ticket checker 105, assuming that the gaming terminal 104 has not already done so via an internal scanner. In this embodiment, it is not necessary for the gaming terminals 104 to include such an internal scanner since the scanner of the integrated ticket checker 105 can provide the same functionality.

M. Matching Characters

In the embodiments described above, numbers are matched to numbers. However, in alternative embodiments, the matching may involve matching non-numerical characters or symbols, and the scope of the present invention includes such embodiments. Since non-numerical characters or symbols are ultimately represented in computer memory as numbers, the comparison of non-numerical characters or symbols is still ultimately a number to number comparison.

Preferred embodiments of the present invention may be implemented as methods, of which examples have been provided. The acts performed as part of the methods may be ordered in any suitable way. Accordingly, embodiments may be constructed in which acts are performed in an order different than illustrated, which may include performing some acts simultaneously, even though such acts are shown as being sequentially performed in illustrative embodiments.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention.

What is claimed is:

1. A gaming system comprising:
(a) a gaming server configured to administer a plurality of successively occurring draw games and a plurality of instant games, wherein the results of previous draw games are used to determine winners of subsequently purchased instant games, the gaming server including a random number generator configured to generate:
(i) results for the draw games, each draw game having its own results, and
(ii) sets of instant game entry numbers;
(b) a plurality of remotely located gaming terminals in communication with the gaming server via an electronic network, each gaming terminal including:
(i) an input device configured to receive from a player a request to purchase one or more instant games, each instant game including a set of instant game entry numbers, and
(ii) a ticket printer configured to print out a ticket for the player that includes a ticket identifier, wherein the ticket identifier identifies one more sets of instant game entry numbers as selected by the random number generator for the one or more instant games purchased by the player,
wherein for each ticket, the gaming server is configured to:
(i) store in a memory the ticket identifier and the respective one or more sets of instant game entry numbers,
(ii) generate the one or more sets of instant game entry numbers when the ticket is purchased, and
(iii) identify whether the ticket is a winning ticket with respect to the one or more instant games by comparing the results of one or more previous draw games with the one or more sets of instant game entry numbers stored in the memory for the respective ticket,
and wherein the instant ticket game results are available immediately after the ticket is printed, and the future draw game results become available only when the future draw game results are generated.

2. The gaming system of claim 1 wherein the ticket printer is further configured to include for each ticket the one or more sets of instant game entry numbers associated with the ticket identifier.

3. The gaming system of claim 1 wherein for each ticket, the gaming server is configured to identify whether the ticket is a winning ticket with respect to the one or more instant games by comparing the results of only the immediately preceding draw game with the one or more sets of instant game entry numbers.

4. The gaming system of claim 1 wherein each gaming terminal further includes
(iii) an output device configured to display game results to the player regarding the one or more instant games on the ticket.

5. The gaming system of claim 1 wherein each game play is associated with a single ticket, the single ticket including one or more instant games.

6. The gaming system of claim 1 wherein the gaming server uses paytables to determine the percentage of winning game results and the value of each winning game result and wherein the same paytable is used for the draw games and the instant games.

7. The gaming system of claim 1 wherein the gaming server uses paytables to determine the percentage of winning game results and the value of each winning game result and wherein different paytables are used for the draw games and the instant games.

8. The gaming system of claim 1 wherein the draw game is a lottery.

9. The gaming system of claim 1 wherein the draw game is keno.

10. A gaming system comprising:
(a) a gaming server configured to administer a plurality of successively occurring draw games and a plurality of instant games, wherein the results of previous draw games are used to determine winners of subsequently purchased instant games, the gaming server including a random number generator configured to generate:
(i) results for the draw games, each draw game having its own results,
(ii) a player's draw game entry numbers upon request by a player to have the gaming server select the draw game entry numbers, and
(iii) sets of instant game entry numbers;
(b) a plurality of remotely located gaming terminals in communication with the gaming server via an electronic network, each gaming terminal including:
(i) an input device configured to receive from a player:
(A) player-selected draw game entry numbers for a future one of the draw games, or a request for the gaming server to randomly select the player's draw game entry numbers for a future one of the draw games,
(B) a request to purchase one or more instant games, each instant game including a set of instant game entry numbers, and
(ii) a ticket printer configured to print out a ticket for the player that includes:
(A) at least one ticket identifier,
(B) an identifier of the future draw game that the ticket is purchased for, and the draw game entry numbers for the future draw game, and
(C) one or more sets of instant game entry numbers as selected by the random number generator for the one or more instant games purchased by the player,
wherein for each ticket, the gaming server is configured to:
(i) store in a memory the at least one ticket identifier, and the draw game entry numbers and the one or more sets of instant game entry numbers that are associated with the at least one ticket identifier,
(ii) generate the one or more sets of instant game entry numbers when the ticket is purchased,
(iii) identify whether the ticket is a winning ticket with respect to the future draw game by comparing the results for each draw game with the draw game identifier and entry numbers on the tickets stored in the memory for the respective ticket, and
(iv) identify whether the ticket is a winning ticket with respect to the one or more instant games by comparing the results of one or more previous draw games with the one or more sets of instant game entry numbers stored in the memory for the respective ticket,
and wherein the instant ticket game results are available immediately after the ticket is printed, and the future draw game results become available only when the future draw game results are generated.

11. The gaming system of claim 10 wherein each game play is associated with a single ticket, the single ticket including a single future draw game and one or more instant games.

12. The gaming system of claim 11 wherein a base amount of funds is equal to the cost of the single future draw game, and additional multiples of the base amount of funds is equal to the cost of a corresponding multiple of instant games, wherein each gaming terminal is further configured to allocate funds received by the player first to the single future draw game, and then to the instant games.

13. The gaming system of claim 10 wherein the ticket printer is configured to print out two ticket identifiers, one ticket identifier being associated with the draw game entry numbers for the future draw game, and the other ticket identifier being associated with the one or more sets of instant game entry numbers.

14. The gaming system of claim 13 further comprising:
(c) a plurality of ticket checkers in communication with the gaming server via the electronic network, each ticket checker configured to:
(i) read the ticket identifier associated with the one or more sets of instant game entry numbers on a previously printed ticket, and
(ii) display game results of the one or more instant games associated with the ticket identifier.

15. The gaming system of claim 10 wherein for each ticket, the gaming server is configured to identify whether the ticket is a winning ticket with respect to the one or more instant games by comparing the results of only the immediately preceding draw game with the one or more sets of instant game entry numbers.

16. The gaming system of claim 10 wherein each gaming terminal further includes
(iii) an output device configured to display game results to the player regarding the one or more instant games on the ticket.

17. The gaming system of claim 10 wherein the gaming server uses paytables to determine the percentage of winning game results and the value of each winning game result and wherein the same paytable is used for the draw games and the instant games.

18. The gaming system of claim 10 wherein the gaming server uses paytables to determine the percentage of winning game results and the value of each winning game result and wherein different paytables are used for the draw games and the instant games.

19. The gaming system of claim 10 wherein the draw game is a lottery.

20. The gaming system of claim 10 wherein the draw game is keno.

21. The gaming system of claim 1 further comprising:
(c) a plurality of ticket checkers in communication with the gaming server via the electronic network, each ticket checker configured to:
(i) read the ticket identifier on a previously printed ticket, and
(ii) display game results of the one or more instant games associated with the ticket identifier.

22. A gaming system comprising:
(a) a gaming server configured to administer a plurality of successively occurring draw games and a plurality of instant games, wherein the results of previous draw games are used to determine winners of subsequently purchased instant games, the gaming server including a random number generator configured to generate:
(i) results for the draw games, each draw game having its own results, and
(ii) sets of instant game entry numbers;
(b) a plurality of remotely located gaming terminals in communication with the gaming server via an electronic network, each gaming terminal including:
(i) an input device configured to receive from a player a request to purchase one or more instant games, each instant game including a set of instant game entry numbers, and
(ii) a ticket printer configured to print out a ticket for the player that includes a ticket identifier,
wherein for each ticket, the gaming server is configured to:
(i) store in a memory the ticket identifier and the respective one or more sets of instant game entry numbers,
(ii) generate the one or more sets of instant game entry numbers when the one or more instant games are played, and
(iii) identify whether the ticket is a winning ticket with respect to the one or more instant games by comparing the results of one or more previous draw games with the one or more sets of instant game entry numbers stored in the memory for the respective ticket,
and wherein the instant ticket game results become available when the ticket is played, and the future draw game results become available only when the future draw game results are generated.

23. The gaming system of claim 22, (Original) The gaming system further comprising:
(c) a plurality of ticket checkers in communication with the gaming server via the electronic network, each ticket checker configured to:
(i) read the ticket identifier on a previously printed ticket, and
(ii) display game results of the one or more instant games associated with the ticket identifier,
wherein the reading of the ticket identifier causes the ticket to be played, thereby causing the gaming server to generate the one or more sets of instant game entry numbers for the ticket.

24. The gaming system of claim 22 wherein for each ticket, the gaming server is configured to identify whether the ticket is a winning ticket with respect to the one or more instant games by comparing the results of only the immediately preceding draw game with the one or more sets of instant game entry numbers.

25. The gaming system of claim 22 wherein each game play is associated with a single ticket, the single ticket including one or more instant games.

26. The gaming system of claim 22 wherein the gaming server uses paytables to determine the percentage of winning game results and the value of each winning game result and wherein the same paytable is used for the draw games and the instant games.

27. The gaming system of claim 22 wherein the gaming server uses paytables to determine the percentage of winning game results and the value of each winning game result and wherein different paytables are used for the draw games and the instant games.

28. The gaming system of claim 22 wherein the draw game is a lottery.

29. The gaming system of claim 22 wherein the draw game is keno.

30. The gaming system of claim 1 further comprising:
(c) a plurality of ticket checkers in communication with the gaming server via the electronic network, each ticket checker configured to:
(i) read the ticket identifier on a previously printed ticket, and
(ii) display game results of the one or more instant games associated with the ticket identifier.
